(19) United States
(12) Patent Application Publication
(10) Pub. No.: US 2017/0302743 A1
(43) Pub. Date: Oct. 19, 2017

(54) Migration

(71) Applicant: HANGZHOU H3C TECHNOLOGIES CO., LTD., Zhejiang (CN)

(72) Inventor: Changwang LIN, Beijing (CN)

(21) Appl. No.: 15/515,915

(22) PCT Filed: Sep. 22, 2015
(86) PCT No.: PCT/CN2015/090223

§ 371 Date: Mar. 30, 2017

(30) Foreign Application Priority Data
Sep. 30, 2014 (CN) 201410519873.3

(51) Int. Cl. H04L 29/08; H04L 12/755; H04L 12/26

(52) U.S. Cl. CPC H04L 67/148; H04L 45/021

(57) ABSTRACT

Examples of the present disclosure may provide a migration method. An emigration TR may receive a map notify message carrying a mapping relationship between an EID of the host and an RLOC of an immigration TR. The emigration TR may make a determination as to whether the RLOC of the immigration TR is same as an RLOC of the emigration TR. The emigration TR may search for an RLOC of a remote TR if the RLOC of the immigration TR is different from the RLOC of the emigration TR. The emigration TR may send an SMR message to the remote TR using the RLOC of the remote TR.

This application claims the benefit of priority from Chinese Patent Application, No. 201410519873.3, entitled “Locator/Identity Separation Protocol (LISP) Host Migration Method and Device” and filed on Sep. 30, 2014, the entire content of which is hereby incorporated by reference.

### BACKGROUND

LISP is a networking solution in which location and identity are separated to form two independent address spaces, i.e. Endpoint Identifier (EID) and Routing Locator (RLOC). The EID is taken as a host address of a communication endpoint. In an LISP network, the function of the EID is similar to that of a Domain Name System (DNS). In the LISP network, the EID may migrate independent of the RLOC. The RLOC is the address of an LISP router. The RLOC may be globally routed in the Internet and may be aggregated according to the network topology condition.

### BRIEF DESCRIPTION OF THE DRAWINGS

FIG. 1 is a flow chart illustrating a host migration method in an LISP network in accordance with various examples of the present disclosure;

FIG. 2 is a flow chart illustrating another host migration method in an LISP network in accordance with various examples of the present disclosure;

FIG. 3 is a flow chart illustrating another host migration method in an LISP network in accordance with various examples of the present disclosure;

FIG. 3A is a flow chart illustrating block 302 in the above FIG. 3 in accordance with various examples of the present disclosure;

FIG. 4 is a schematic diagram illustrating networking of an LISP network in accordance with various examples of the present disclosure;

FIG. 4A is a flow chart illustrating another host migration method in an LISP network in accordance with various examples of the present disclosure;

FIG. 5 is a schematic diagram illustrating networking of another LISP network in accordance with various examples of the present disclosure;

FIG. 5A is a flow chart illustrating another host migration method in an LISP network in accordance with various examples of the present disclosure;

FIG. 6 is a schematic diagram illustrating networking of another LISP network in accordance with various examples of the present disclosure;

FIG. 6A is a flow chart illustrating another host migration method in an LISP network in accordance with various examples of the present disclosure;

FIG. 7 is a schematic diagram illustrating structure of a device implementing host migration in an LISP network in accordance with various examples of the present disclosure;

FIG. 8 is a schematic diagram illustrating structure of another device implementing host migration in an LISP network in accordance with various examples of the present disclosure;

FIG. 9 is a schematic diagram illustrating structure of a Tunnel Router (TR) in accordance with various examples of the present disclosure; and

FIG. 10 is a schematic diagram illustrating structure of another TR in accordance with various examples of the present disclosure.

### DETAILED DESCRIPTION

In an example of the present disclosure, the LISP network may include Tunnel Routers (TR)s, a Map Server/Map Resolver (MS/MR), a Map Database (Map DB) on the MS/MR and hosts.

The Map DB may record a mapping relationship between each RLOC and each EID.

In examples of the present disclosure, the migration of the host may refer to a process that the host may move from one TR or to another. A TR providing packet and traffic forwarding for the host before the host migrates out from the TR may be called an emigration TR. A TR providing packet and traffic forwarding for the host after the host migrates to the TR may be called an immigration TR.

In an example of the present disclosure, the TRs may include a TR, from which a host may migrate out, i.e. an emigration TR and a TR, to which the host may migrate, i.e. an immigration TR.

In an example of the present disclosure, a TR1 may locate at an LISP site A and a TR2 may locate at an LISP site B. Before the migration of the host, the host may locate at the LISP site A, connect with the TR1 and receive/send a packet from/to a remote TR, i.e. TR3. After the connection relationship changes, the host may migrate to the TR2 in the LISP site B. After traffic migration is finished, the host may receive/send the packet from/to the TR3 via the TR2.

In an example of the present disclosure, the TR1 may be the TR, from which the host may migrate out, i.e. the emigration TR and the TR2 may be the TR, to which the host may migrate, i.e. the immigration TR.

A process that the host may migrate from the TR1 to the TR2 and a process of traffic migration after the migration of the host may be described hereinafter.

1) When the host migrates to the TR2 from the TR1, the TR2 may receive an Address Resolution Protocol (ARP) packet or data packet from the host. If the TR2 may receive the ARP packet or data packet from the host, the TR2 may sense that the host may have migrated to the TR2.

2) The TR2 may send a registration message to the MS to register the EID of the host with the MS.

3) The MS may search the Map DB for the RLOC of the emigration TR, i.e. the RLOC of the TR1 using the EID of the host, send a map notify message to the TR1 to notify the TR1 that the host may have migrated out from the TR1.

4) After the TR1 receives the map notify message, the TR1 may set the host to be in an out-migrated state.

5) After the TR1 receives a packet, which is sent to the host, the TR1 may send a Solicit Map Request (SMR) message to the TR3, which may sent out the packet. The SMR message may carry the EID of the host. The SMR message may be sent to the TR3 to notify the TR3 of requesting for the RLOC of the immigration TR, i.e. the TR2 and the packet may be discarded.

6) After the TR3 receives the SMR message, the TR3 may send a map request message carrying the LID of the host to the MR. The MR may forward the map request message to the MS. The MS may search the Map DB for the RLOC of the TR2 corresponding to the EID of the host and forward the map request message to the TR2. The TR2 may carry the mapping relationship between the EID of the host and the RLOC of the TR2 in a map response message and send the map response message to the TR3. The TR3 may replace the mapping relationship between the EID of the host and the RLOC of the TR1 with the mapping relationship between the EID of the host and the RLOC of the TR2. The TR3 may send the packet for the host to the TR2 instead of the TR1.

It can be seen from the above migration process of the host, when the host starts the migration, the mapping relationship between the EID of the host and the RLOC stored in the TR3 may be the mapping relationship between the Eli) of the host and the RLOC of the TR1. The TR3 may send the packet for the host to the TR] If the TR1 and the TR2 are not located at the same extended Local Area Network (LAN), after the TR1 receives the map notify message carrying the mapping relationship between the EID of the host and the RLOC of the TR2 from the MS, the TR1 may obtain that the host may have migrated out from the TR1. If the TR1 and the TR2 are located at the same extended LAN, after the TR1 receives the map notify message carrying the mapping relationship between the LID of the host and the RLOC of the TR2 from the MS or TR2, the TR1 may obtain that the host may have migrated out from the TR1. Then, when the TR1 receives the packet sent from the TR3 to the host, the TR1 may send the SMR message to the TR3 to notify the TR3 of requesting for the mapping relationship between the host and the RLOC of the TR2. After the TR3 obtains the mapping relationship between the host and the RLOC of the TR2, the TR3 may send the packet for the host to the TR2 using the RLOC of the TR2 to finish the migration of the traffic.

In the above example, the TR1 may trigger the TR3 to execute the above traffic migration operation after the TR1 receives the packet, which is sent from the TR3 to the host. The time used by the migration may he affected by the moment that the TR3 may send out the packet.

After the migration of the host, in order to speed up update of the mapping relationship on the remote TR and shorten convergence time of the LISP network, examples of the present disclosure may provide other host migration solutions implemented in the LISP network.

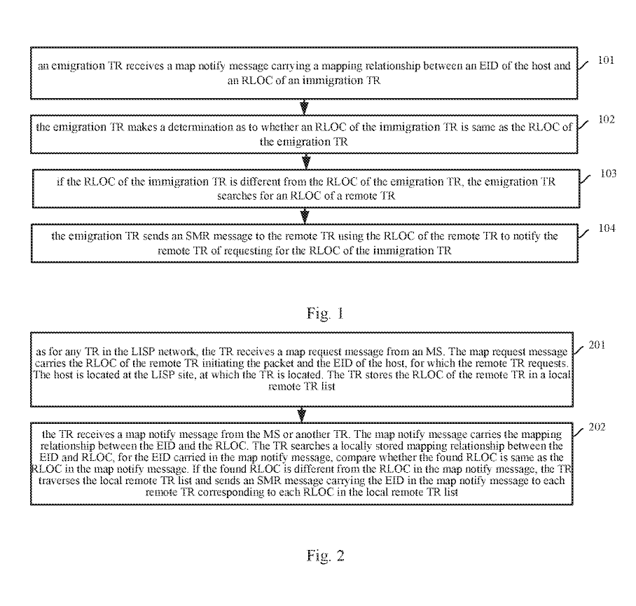

FIG. 1 is a flow chart illustrating a host migration method in an LISP network in accordance with various examples of the present disclosure. The method may include following blocks.

At block 101, an emigration TR may receive a map notify message carrying a mapping relationship between an EID of the host and an RLOC of an immigration TR.

At block 102, the emigration TR may make a determination as to whether an RLOC of the immigration TR is same as the RLOC of the emigration TR.

At block 103, if the RLOC of the immigration TR is different from the RLOC of the emigration TR, the emigration TR may search for an RLOC of a remote TR.

At block 104, the emigration TR may send an SMR message to the remote TR using the RLOC of the remote TR to notify the remote TR of requesting for the RLOC of the immigration TR.

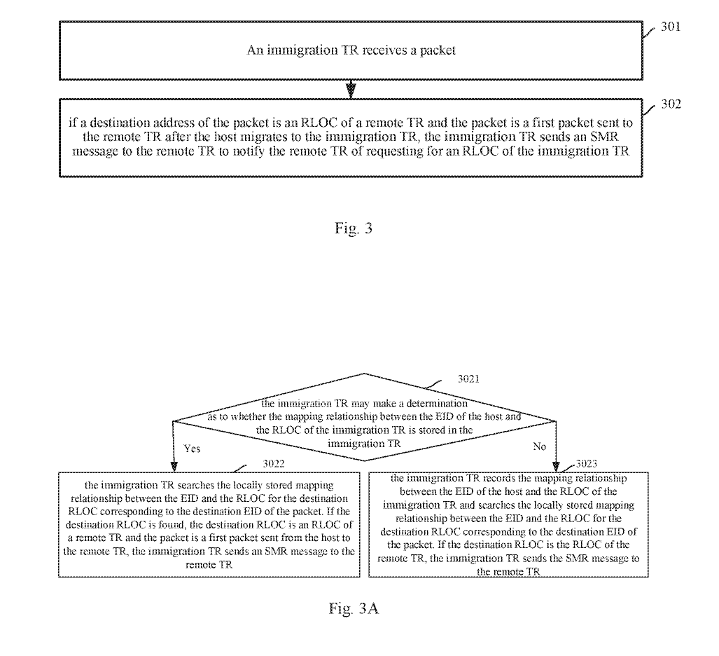

FIG. 2 is a flow chart illustrating another host migration method in an LISP network in accordance with various examples of the present disclosure. The method may include following blocks.

At block 201, as for any TR in the LISP network, the TR may receive a map request message from an MS. The map request message may carry the RLOC of the remote TR initiating the packet and the EID of the host, for which the remote TR may request. The host may be located at the LISP site, at which the TR may be located. The TR may store the RLOC of the remote TR in a local remote TR list.

In an example of the present disclosure, suppose that the LISP network may include two “TRs, i.e. TR A and TR B. As for TR A and TR B, one TR may be the remote TR of the other. The TR A may connect with a host a and TR B may connect with a host b.

01: The TR B may receive a packet from the host b. A destination address of the packet from the host h may be the EID of the host a. The TR B may search the locally stored mapping relationship between the EID and the RLOC for the EID of the host a and send a map request message to an MR. The source address of the map request message may be the RLOC of the TR B. The map request message may further carry the EID of the host a, to request for the RLOC corresponding to the EID of the host a.

02: After the MR receives the map request message, the MR may forward the map request message to the MS. The MS may search the Map DB for the RLOC corresponding to the EID of the host a, i.e. the RLOC of the TR A. The MS may forward the map request message to the TR A. Therefore, the TR A may receive the map request message sent by the remote TR, i.e. TR B. According to the block 201, the TR A may save the RLOC of the TR B in the local remote TR list.

In an example of the present disclosure, the LISP network may include three TRs, i.e. TR A, TR B and TR C. As for any two TRs in the three TRs, one TR may be the remote TR of the other TR. The TR B may connect with the host b.

01: The host b may migrate from the TR B to the TR A. The TR A may send a registration packet carrying the EID of the host h to the MS. After the MS receives the registration packet, the MS may send a map notify message to the emigration TR, i.e. the TR B to notify the TR B that the host b may have migrated out.

02: The TR B may receive the map notify message. After the TR B receives a packet, which is sent from the TR C to the host b, since the host b has migrated out from the TR B, the TR B may send an SMR message carrying the EID of the host h to trigger the TR C to re-request for the RLOC of the immigration TR.

03: After the TR C receives the SMR message, the TR C may send the map request message carrying the EID of the host b to the MR. The MR may forward the map request message to the MS. The MS may forward the map request message to the immigration TR, i.e. TR A. The TR A may send a map response message carrying a mapping relationship between the EID of the host b and the RLOC of the TR A to the TR C. According to the block 201, the TR A may save the RLOC of the TR C in the local remote TR list.

After the TR stores the RLOC of the remote TR in the local remote TR list, the TR may put the mapping relationship between the EID of the host and the RLOC of the TR in the map response message, add a life cycle of a mapcache table entry in the map response message and send the map response message to the remote TR initiating the map request message.

The method for storing the RLOC of the remote TR in the local remote TR list may include that the TR may make a determination as to whether the RLOC of the remote TR may have stored in the local remote TR list. If the RLOC of the remote TR has been stored in the local remote TR list, an aging timer of the RLOC may be re-initiated. If the RLOC of the remote TR has not been stored in the local remote TR list, the RLOC of the remote TR may be stored in the local remote TR list and the aging timer may be set for the RLOC of the remote TR.

When the aging timer of any RLOC in the local remote TR list expires, the RLOC and the aging timer may be deleted.

The aging time of the aging timer of the RLOC may be the lift cycle of the mapcache table entry (i.e. the mapping relationship between the RLOC and the EID) in the map response message.

At block 202, the TR may receive a map notify message from the MS or another TR. The map notify message may carry the mapping relationship between the EID and the RLOC. The TR may search a locally stored mapping relationship between the EID and RLOC, for the EID carried in the map notify message, compare whether the found RLOC is same as the RLOC in the map notify message. If the found RLOC is different from the RLOC in the map notify message, the TR may traverse the local remote TR list and send an SMR message carrying the EID in the map notify message to each remote TR corresponding to each RLOC in the local remote TR list.

When the TR receives the map notify message from another TR, if the found RLOC is same as the RLOC in the map notify message, the TR may make a determination that the host corresponding to the EID in the map notify message may have migrated to the TR and update the locally stored mapping relationship according to the mapping relationship between the EID and RLOC in the map notify message.

The process of receiving the map notify message from the MS may be as follows.

When the host migrates out from the TR, after the immigration TR senses the host. The immigration TR may send a registration message carrying the mapping relationship between the EID of the host and the RLOC of the immigration TR. After the MS receives the registration message, the MS may search the local Map DB for the RLOC of the TR (i.e. the emigration TR) corresponding to the EID of the host. The MS may send the map notify message carrying the mapping relationship between the EID of the host and the immigration TR and replace the RLOC of the emigration TR corresponding to the EID of the host in the Map DB with the RLOC of the immigration TR.

The process of receiving the map notify message from another TR may be as follows.

When multiple TRs are located at a same multicast network, such as a Local Area Network (LAN) or extended LAN, when a TR in the multicast network finds that a host migrates to the local LISP site, the TR may multicast the map notify message in the multicast network. The map notify message may carry the mapping relationship between the EID of the host and the RLOC of the TR (i.e. the immigration TR). The TR may further send a registration message carrying the mapping relationship between the EID of the host and the RLOC of the TR. At block 202, the map notify message received by the TR from another TR may be the map notify message multicast by the another TR in the multicast network, at which the TR may be located, after the another TR senses that the host may have migrated to the local LISP site.

At block 202, after the TR receives the map notify message from the another TR and before the TR searches the locally stored mapping list between the EM and RLOC, i.e. the mapping list recording the mapping relationship between the EID and the RLOC for the EID carried by the map notify message, the TR may further make a determination as to whether the EID carried by the map notify message is stored in the mapping list between the EID and the RLOC. If the EID carried by the map notify message is not stored in the map list between the EID and the RLOC, the TR may record the mapping relationship between the EID carried by the map notify message and the RLOC in the mapping list between the EID and RLOC, but may not send the SMR message. If the EID carried by the map notify message is stored in the mapping list between the EID and the RLOC, the TR may search the mapping list between the EID and RLOC for the EID carried by the map notify message.

As for a multicast network, when the host migrates to a TR in the multicast network, the TR may multicast the map notify message in the multicast network. Therefore, all TRs except for the emigration TR in the multicast network may receive the map notify message. The emigration TR may not need to send the SMR message. Therefore, in an example of the present disclosure, after the TR receives the map notify message from another TR, the TR may make a determination as to whether the EID carried by the map notify message is stored in the mapping list between the EID and the RLOC. If the EID carried by the map notify message is not stored in the mapping list between the EID and the RLOC, the TR may not be the emigration TR and may not send the SMR message.

After block 202, when any remote TR receives the SMR message, the remote TR may send the map request message to the MR. The map request message may carry the EID in the SMR message. After the MR receives the map request message, the MR may forward the map request message to the MS. The MS may search the local Map DB for the RLOC corresponding to the EID in the SMR message and forward the map request message to the TR (i.e., the immigration TR) corresponding to the RLOC. The immigration TR may receive the map request message, carry the mapping relationship between the EID and the RLOC of the immigration TR in the map response message and send the map response message to the remote TR.

Therefore, the remote TR may know the BLOC of the immigration TR and may send the traffic to the immigration TR to finish the migration of the traffic.

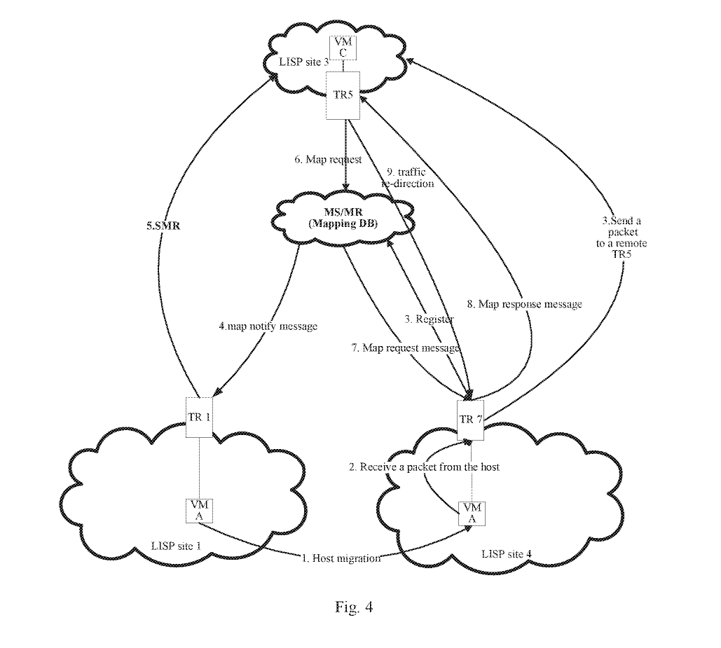

FIG. 3 is a flow chart illustrating another host migration method in an LISP network in accordance with various examples of the present disclosure. The method may include following blocks.

At block 301, an immigration TR may receive a packet.

At block 302, if a destination address of the packet is an RLOC of a remote TR and the packet is a first packet sent to the remote TR after the host migrates to the immigration TR, the immigration TR may send an SNIP, message to the remote TR to notify the remote TR of requesting for an RLOC of the immigration TR.

FIG. 3A is a flow chart illustrating block 302 in the above FIG. 3 in accordance with various examples of the present disclosure. The block 302 may include following blocks.

At block 3021, the immigration TR may make a determination as to whether the mapping relationship between a source address (i.e. the EID of the host initiating the packet) of the packet and the RLOC of the immigration TR is stored in the immigration TR. If the mapping relationship is stored the immigration TR, block 3022 may be executed. If the mapping relationship is not stored in the immigration TR, block 3023 may be executed.

At block 3022, the immigration TR may search the locally stored mapping relationship between the EID and the RLOC for the destination RLOC corresponding to the destination EID of the packet. If the destination RLOC corresponding to a destination LID of the packet is found, the destination RLOC is an RLOC of a remote TR and the packet is a first packet sent from the host to the remote TR, the immigration TR may send an SMR message to the remote TR. If the destination RLOC is not the RLOC of the remote TR or the packet is not the first packet sent from the host to the remote TR, the immigration TR may not initiate the SMR message. Block 302 may be terminated.

Block 3022 may describe a situation that the immigration TR may have recorded the mapping relationship between the source address (i.e. the EID of the host) of the packet and the RLOC of the immigration TR. That is, after the host migrates to the TR, the host may have initiated other packets (ARP packets or data packets), so that the immigration TR may have recorded the mapping relationship between the EID of the host and the RLOC of the immigration TR. Therefore, the immigration TR may need to make a determination as to whether the packet is the first packet sent to the remote TR corresponding to the destination RLOC. If the packet is the first packet sent to the remote TR corresponding to the destination RLOC, the immigration TR may need to send the SMR message to the remote TR If the destination RLOC corresponds to the immigration TR (i.e. non-remote TR) or the packet is not the first packet sent from the host to the remote TR, the immigration TR may not need to initiate the SMR message.

At block 3023, the immigration TR may record the mapping relationship between the source address (i.e. the EID of the host) of the packet and the RLOC of the immigration TR and search the locally stored mapping relationship between the EID and the RLOC for the destination RLOC corresponding to the destination EID of the packet. If the destination RLOC is the RLOC of the remote TR, the immigration TR may send the SMR message to the remote TR.

Block 3023 may describe a situation that the immigration TR may have not recorded the mapping relationship between the source address (i.e. the EID of the host) of the packet and the RLOC of the immigration TR.. That is, the packet may be the first packet after the host migrates to the TR. If the packet is sent from the host to the remote TR, the immigration TR may send the SMR message to the remote TR.

When the remote TR receives the SMR message, the remote TR may send the map request message to the MR. The map request message may carry the EID in the

SMR message. The MR may receive the map request message and forward the map request message to the MS. The MS may search the local Map DB for the RLOC corresponding to the EID and forward the map request message to the TR corresponding to the RLOC (i.e. the immigration TR). The immigration TR may receive the map request message, carry the mapping relationship between the EID and the RLOC of the immigration TR in the map response message and send the map response message to the remote TR.

Therefore, the remote TR may obtain the RLOC of the immigration TR and send traffic to the immigration TR to finish the traffic migration,

In an example of the present disclosure, the example illustrated by FIG. 2 and the example illustrated by FIG. 3 may be combined together.

Three application examples may be given hereinafter.

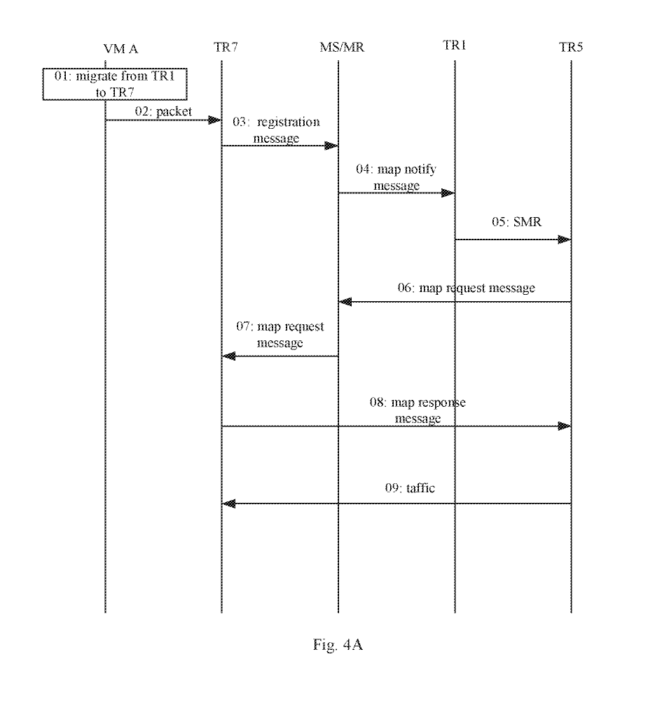

FIG. 4 is a schematic diagram illustrating networking of an LISP network in accordance with various examples of the present disclosure. As for any two TRs of TR1, TR5 and TR7, one TR may be the remote TR of the other TR. Before migration. Virtual Machine (VM) A may be located at an LISP site 1.

After TR1, TR5 and TR7 start, if a map request message is received from the MS, the RLOC of the remote TR initiating the map request message may be stored in a local remote TR list. The remote TR lists of TR1, TR5 and TR7 may be as follows.

The remote TR list of TR1 may include the RLOCs of TR5 and TR7.

The remote TR list of TR5 may include the RLOCs of TR1 and TR7.

The remote TR list of TR7 may include the RLOCs of TR1 and TR5.

FIG. 4A is a flow chart illustrating another host migration method in an LISP network in accordance with various examples of the present disclosure.

Referring FIG. 4A, at a moment, the VM A may migrate from the LISP site 1 to the LISP site 4, the migration process may be as follows.

01: The VMA may migrate out from the TR1 in the LISP site 1 to the TR7 in the LISP site 4.

02: The VM A may initiate a data packet. The destination address of the data packet may be the EID of the VM C in the LISP site 3.

03: When the TR7 receives the data packet, the TR7 may search the mapping relationship between the EID and the RLOC for the EID of the VM A. If the TR7 does not find the EID of the VM A, the TR7 may obtain that the VM A may be the host, which may newly migrate to the TR7 and send a registration message to the MS. The registration message may carry the mapping relationship between the EID of the VMA and the RLOC of the TR7. The TR7 may send the data packet to the TR5 according to the RLOC corresponding to the EID of the VM C.

04: The MS may receive the registration message from the TR 7, search the local Map DB for the RLOC corresponding to the EID of the VM A. i.e. the RLOC of the TR1 and send a map notify message to the TR1. The map notify message may carry the mapping relationship between the EID of the VM A and the RLOC of the TR7. The MS may further replace the RLOC corresponding to the EID of the VM A in the Map DB with the RLOC of the TR7.

05: The TR1 may receive the map notify message from the MS and find that the EID in the map notify message may have been recorded in the locally stored mapping relationship between the EID and RLOC. If the RLOC in the map notify message is different from the local RLOC in the mapping relationship, the TR1 may make a determination that the host (i.e. VM A) corresponding to the EID in the map notify message may have migrated from the TR1, traverse the remote TR list of the TR1 and send the SMR message to the remote TR corresponding to each RLOC (i.e. the TR5). The SMR message may carry the EID of the VM A in the map notify message.

The RLOC carried by the map notify message may be the RLOC of the TR7. Therefore, the TR1 may need to send the SMR message to the TR5 instead of the TR7.

06: The TR5 may receive the SMR message from the TR1 and send a map request message carrying the EID of the VM A to the MR/MS.

07: The MS may receive the map request message from the TR5 search the local Map DB for the RLOC corresponding to the EID of the VM A, i.e. the RLOC of the TR7 and send the map request message to the TR7.

08: The TR7 may receive the map request message from the MS, carry the mapping relationship between the EID of the VM A and the RLOC of the TR7 in the map response message and send the map response to the TR5.

09: The TR5 may receive the map response message and replace the mapping relationship corresponding to the EID of the VM A with the mapping relationship in the map response message. Traffic, which may be sent by a host in the LISP site 3 to the VM A, may be routed to the TR7.

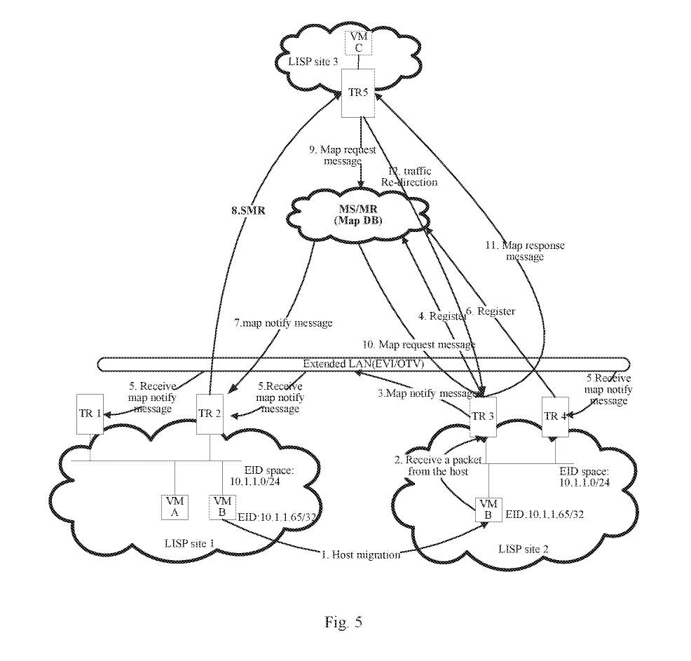

FIG. 5 is a schematic diagram illustrating networking of another LISP network in accordance with various examples of the present disclosure. The TR1, TR2, TR3 and TR4 may be located at the same extended LAN. Before migration, the VM A and VM B may be located at the LISP site 1 and may respectively connect with the TR1 and TR2.

After TR1 to TR5 start, if a map request message is received from the MS, the RLOC of the remote TR initiating the map request message may be stored in a local remote TR list. The remote TR lists of TR1 to TR5 may be as follows.

The remote TR lists of TR 1 to TR4 may include the RLOC of TR5.

The remote TR list of the TR5 may include RLOCs of TR1 to TR4.

FIG. 5A is a flow chart illustrating another host migration method in an LISP network in accordance with various examples of the present disclosure.

Referring FIG. 5A, at a moment, the VM B may migrate from the LISP site 1 to the LISP site 2, the migration process may be as follows.

01: The VM B may migrate out from the LISP site 1 to the LISP site 2 and connect with the TR3 and TR4.

02: The VM B may initiate a data packet. The destination address of the data packet may be the EID of the VM C in the LISP site 3.

03-04: When the TR3 receives the data packet, the TR3 may search the locally stored mapping relationship between the EID and the RLOC for the EID of the VM B. If the TR3 does not find the EID of the VM B, the TR3 may obtain that the VM B may be the host, which may newly migrate to the TR3 and send a registration message to the MS and multicast the map notify message in the extended LAN. The registration message and the map notify message may carry the mapping relationship between the EID of the VM B and the RLOCs of the TR3 and TR4.

Since the VM B may simultaneously connect with the TR3 and TR4, the EM of the VM B may be mapped into RLOCs of two TRs, i.e. the TR3 and TR4.

05 to 08: The TR4 may receive the map notify message from the TR3 and find that the TR4 may not store the EID in the mapping relationship between the EID and the RLOC in the map notify message, and make a determination that the VM B may be a host, which may newly migrate to the TR4, record the mapping relationship in the map notify message, send a registration message carrying the mapping relationship to the MS.

The MS may receive the registration from the TR3 and find the RLOCs corresponding to the EID of the VM B, i.e. the RLOCs of the TR1 and TR2. The MS may send the map notify message to the TR1 or TR2. The map notify message may carry the mapping relationship between the EID of the VM B and RLOCs of the TR3 and TR4. The MS may replace the RLOCs corresponding to the EID of the VM B in the Map DB with the RLOCs of the TR1 and TR4.

The TR1 and TR2 may receive the map notify message from the TR3 or MS and find that EID in the map notify message may have recorded in the locally stored mapping relationship between the EID and the RLOC. If the RLOC in the map notify message is different from the RLOC in the locally stored mapping relationship, the TR1/TR2 may traverse the local remote TR list and send the SMR message to the remote TR corresponding to each RLOC in the local remote TR list. The SMR message may carry the EID in the map notify message.

09: The remote TR, such as TR5 may receive the SMR message from the TR1/TR2 and send the map request message carrying the EID of the VM B to the MR/MS.

10: The MS may receive the map request message from the TR5, search the local Map DB for the RLOCs corresponding to the EID of the VM B, i.e. the RLOCs of the TR3 and TR4 and send the map request message to the TR3 or TR4.

11: The TR3 or TR4 may receive the map request message from the MS, carry the mapping relationship between the EID of the VM B and the RLOCs of the TR3 and TR4 in the map response message and send the map response to the TR5.

12: The TR5 may receive the map response message and replace the mapping relationship corresponding to the EID of the VM B with the mapping relationship in the map response message. Traffic, which may be sent by a host in the LISP site 3 to the VM B, may be routed to the TR3 or TR4.

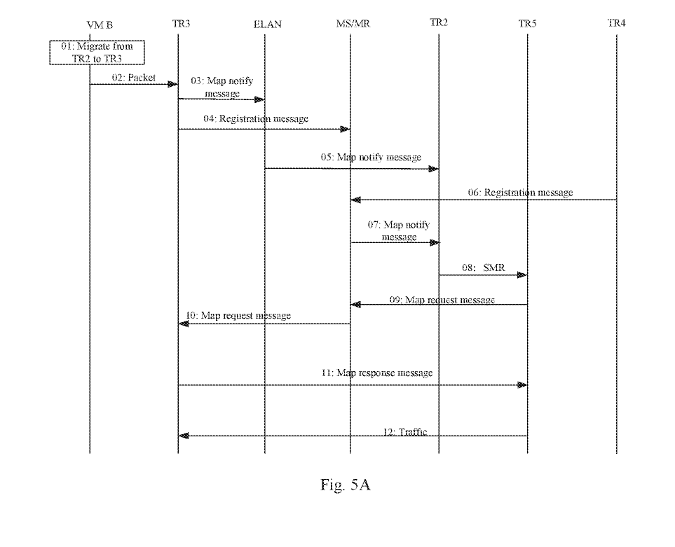

FIG. 6 is a schematic diagram illustrating networking of another LISP network in accordance with various examples of the present disclosure. The TR1, TR2, TR3 and TR4 may be located at the same extended LAN. Before migration, the VM A and VM B may be located at the LISP site 1 and may respectively connect with the TR1 and TR2.

After TR1 to TR5 start, if a map request message is received from the MS, the RLOC of the remote TR initiating the map request message may be stored in a local remote TR list. The remote TR lists of TR1 to TR5 may be as follows.

The remote TR lists of TR 1 to TR4 may include the RLOC of TR5.

The remote TR list of the TR5 may include RLOCs of TR1 to TR4.

FIG. 6A is a flow chart illustrating another host migration method in an LISP network in accordance with various examples of the present disclosure.

Referring FIG. 6A, at a moment, the VM B may migrate from the LISP site 1 to the LISP site 2, the migration process may be as follows.

01: The VM B may migrate out from the LISP site 1 to the LISP site 2 and connect with the TR3 and TR4.

02: The VM B may initiate a data packet. The destination address of the data packet may be the EID of the VM C in the LISP site 3.

03 to 04: When the TR3 receives the data packet, the TR3 may search the locally stored mapping relationship between the EID and the RLOC for the EID of the VM B. If the TR3 does not find the EID of the VM B, the TR3 may obtain that the VM B may be the host, which may newly migrate to the TR3 and send a registration message to the MS and multicast the map notify message in the extended LAN. The registration message and the map notify message may carry the mapping relationship between the EID of the VM B and the RLOCs of the TR3 and TR4. The TR3 may search the locally stored mapping relationship between the EID and the RLOC for the RLOC of the IRS corresponding to the EID of the VM C, send the SMR message carrying the EID of the VM B to the TR5 and send the data packet to the TR5.

05 to 08: The TR4 may receive the map notify message from the TR3 and find that the TR4 may not store the EID in the mapping relationship between the EID and the RLOC in the map notify message, and make a determination that the VM B may be a host, which may newly migrate to the TR4, record the mapping relationship in the map notify message, send a registration message carrying the mapping relationship to the MS.

The MS may receive the registration message from the TR3 and find the RLOCs corresponding to the EID of the VM B, i.e. the RLOCs of the TR1 and TR2. The MS may send the map notify message to the TR1 or TR2. The map notify message may carry the mapping relationship between the EID of the VM B and RLOCs of the TR3 and TR4. The MS may replace the RLOCs corresponding to the EID of the VM B in the Map DB with the RLOCs of the TR3 and TR4.

The TR1 and TR2 may receive the map notify message from the TR3 or MS and find that EID in the map notify message may have recorded in the locally stored mapping relationship between the EID and the RLOC. If the RLOC in the map notify message is different from the RLOC in the locally stored mapping relationship, the TR1/TR2 may replace the locally stored mapping relationship with the mapping relationship in the map notify message.

The IRS may receive the SMR message from the TR3 and send the map request message carrying the EID of the VM B to the MR/MS,

09: The MS may receive the map request message from the TR5, search the local Map DB for the RLOCs corresponding to the EID of the VM B, i.e, the RLOCs of the TR3 and TR4 and send the map request message to the TR3 or TR4.

10: The TR3 or TR4 may receive the map request message from the MS, carry the mapping relationship between the EID of the VM B and the RLOCs of the TR3 and TR4 in the map response message and send the map response message to the TR5.

11: The TR5 may receive the map response message and replace the locally stored mapping relationship corresponding to the EID of the VM B with the mapping relationship in the map response message. Traffic, which may be sent from a host in the LISP site 3 to the VM B, may be routed to the TR3 or TR4.

In examples of the present disclosure, the TR may maintain the remote TR list. After the host migrates and after the emigration TR receives the map notify message carrying the EID of the host from the MS or immigration TR, the emigration

TR may send the SMR message carrying the EID of the host to all remote TRs in the remote TR list to speed up the migration of the traffic. Alternatively, after the immigration TR senses that the host has migrated to itself and the immigration TR receives the first packet, which may he sent from the host to the remote TR, the immigration TR may send the SMR message carrying the EID of the host to the remote TR to speed up the migration of the traffic.

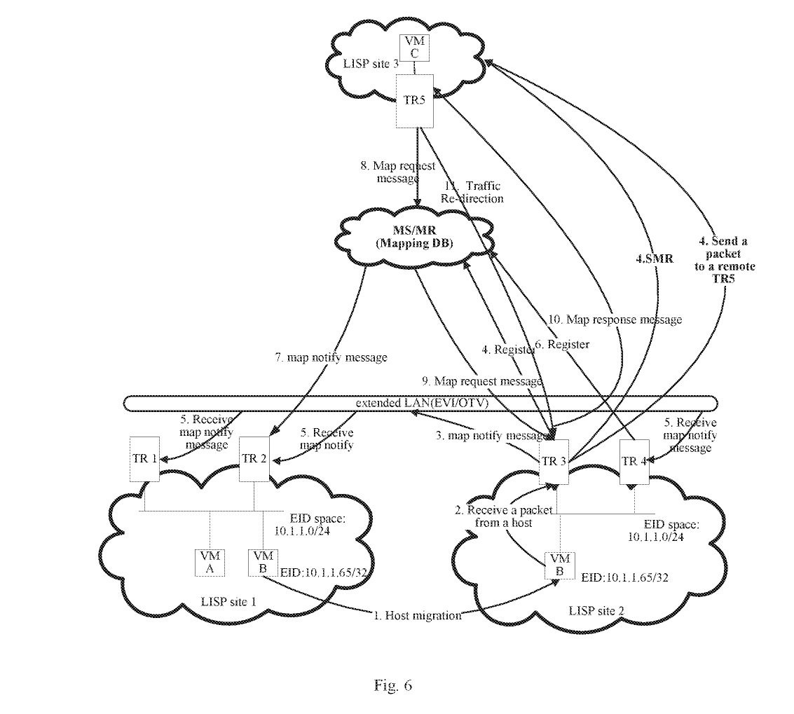

FIG. 7 is a schematic diagram illustrating structure of a device implementing host migration in an LISP network in accordance with various examples of the present disclosure. The device may he installed on a TR. The device may include: a remote TR list maintaining module 701 and a map request triggering module 702.

The remote TR list maintaining module 701 may he configured to receive a map request message carrying an RLOC of a remote TR and an EID of a host from an MS and store the RLOC of the remote TR in a local remote TR list,

The map request triggering module 702 may be configured to receive a map notify message carrying a mapping relationship between the EID and the RLOC from the MS or another TR, search a locally stored mapping relationship between the EID and RLOC for the RLOC corresponding to the EID carried in the map notify message, compare whether the found RLOC is same as the RLOC in the map notify message, send an SMR message to each remote TR corresponding to the RLOC in the remote TR list maintained by the remote TR list maintaining module 701 if the found RLOC is different from the RLOC in the map notify message. The SMR message may carry the EID in the map notify message.

When map request triggering module 702 receives the map notify message from another TR, before the map request triggering module 702 searches the locally stored mapping relationship between the EID and RLOC for the RLOC corresponding to the EID in the map notify message, the map request triggering module 702 may be further configured to search the locally stored mapping relationship between the EID and RLOC for the EID carried by the map notify message and search the locally stored mapping relationship between the EID and RLOC for the RLOC corresponding to the EID in the map notify message if the EID carried by the map notify message is found in the locally stored mapping relationship.

After the remote TR list maintaining module 701 receives the map request message from the MS and before the remote TR list maintaining module 701 stores the RLOC of the remote TR in the local remote TR list, the remote TR list maintaining module 701 may be further configured to make a determination as to whether the RLOC of the remote TR is stored in the local remote TR list, store the RLOC of the remote TR in the local remote TR list if the RLOC of the remote TR is not stored in the local remote TR list, set an aging timer for the RI:0C of the remote TR, reset the aging timer set for the RLOC of the remote TR if the RLOC of the remote TR is stored in the local remote TR list and delete the aging timer and the RLOC of the remote TR if aging timer set for the RLOC of the remote TR in the remote TR list expires.

After the remote TR list maintaining module 701 stores the RLOC of the remote TR in the local remote TR list, the remote TR list maintaining module 701 may be further configured to carry the mapping relationship between the EID of the host and the RLOC of the TR in a map response message, set a life cycle for the mapping relationship in the map response message and send the map response message to the remote TR. The aging time of the aging timer may be the life cycle set for the mapping relationship.

The map request triggering module 702 may be configured to receive a data packet from any host in the LISP site, at which the TR may be located, and send an SMR message carrying the EID of the host to the remote TR if a TR corresponding to a destination address of the data packet is the remote TR and the data packet is the first packet sent from the host to the remote TR.

After the map request triggering module 702 receives the data packet from any host in the LISP site, before the map request triggering module 702 sends the SMR message to the remote TR, the map request triggering module 702 may be further configured to make a determination as to whether the TR records the mapping relationship between the EID of the host and the RLOC. If the TR records the mapping relationship between the EID of the host and the RLOC, the map request triggering module 702 may be further configured to search the locally stored mapping relationship between the EID and the RLOC for the destination RLOC corresponding to the destination EID of the data packet. If the destination RLOC is the RLOC of the remote TR and the data packet is the first packet sent from the host to the remote TR, the map request triggering module 702 may be further configured to send the SMR message to the remote TR. If the TR does not record the mapping relationship between the EID of the host and the RLOC, the map request triggering module 702 may be further configured to record the mapping relationship between the EID of the host and the RLOC of the TR, search the locally stored mapping relationship between the EID and the RLOC for the destination RLOC corresponding to the destination EID of the data packet. If the destination RLOC is the RLOC of the remote TR, the map request triggering module 702 may be further configured to send the SMR message to the remote TR.

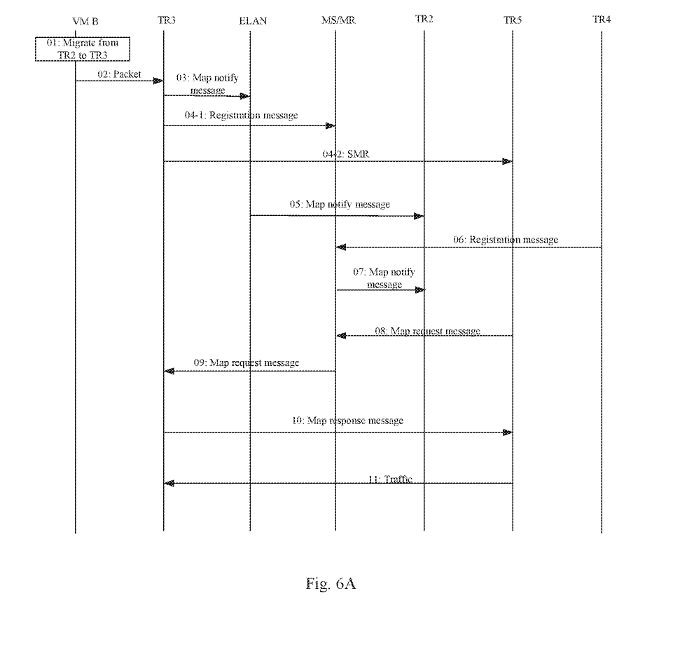

FIG. 8 is a schematic diagram illustrating structure of another device implementing host migration in an LISP network in accordance with various examples of the present disclosure. The device may be installed on a TR. The device may include:

a packet receiving module 801, to receive a data packet for any host in an LISP site, at Which the TR may be located; and

a map request triggering module 802, to send an SMR message to a remote TR if a TR corresponding to a destination address of the data packet is the remote TR and the data packet is the first packet sent from the host to the remote TR. The SMR message may carry the EID of the host.

After the map request triggering module 802 receives the data packet from any host in the LISP site, before the map request triggering module 802 sends the

SMR message to the remote TR, the map request triggering module 802 may he further configured to make a determination as to whether the TR records the mapping relationship between the EID of the host and the RLOC. If the TR records the mapping relationship between the EID of the host and the RLOC, the map request triggering module 802 may he further configured to search the locally stored mapping relationship between the EID and the RLOC for the destination RLOC corresponding to the destination EID of the data packet. If the destination RLOC is the RLOC of the remote TR and the data packet is the first packet sent from the host to the remote TR, the map request triggering module 802 may be further configured to send the SMR message to the remote TR. If the TR does not record the mapping relationship between the EID of the host and the RLOC, the map request triggering module 802 may be further configured to record the mapping relationship between the EID of the host and the RLOC of the TR, search the locally stored mapping relationship between the EID and the RLOC for the destination RI:0C corresponding to the destination EID of the data packet. If the destination RLOC is the RLOC of the remote TR, the map request triggering module 802 may be further configured to send the SMR message to the remote TR.

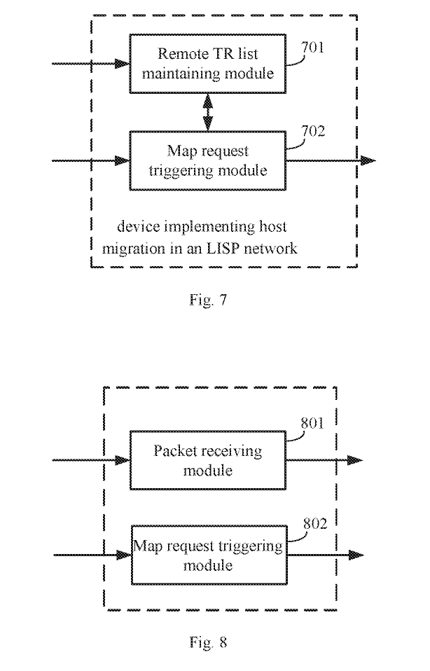

The TR in this example of the present disclosure may be a programmable device including hardware and machine readable instructions. The hardware architecture of the TR may be shown in FIG. 9. FIG. 9 is a schematic diagram illustrating structure of a TR in accordance with various examples of the present disclosure. The TR may be an emigration TR. The emigration TR may include: a CPU 901, a non-transitory storage 902 and a network interface 903.

The non-transitory storage 902 may be configured to store machine readable instructions.

The CPU 901 may communicate with the non-transitory storage 902 to read and execute the machine readable instructions on the non-transitory storage 902, to
receive a map notify message carrying a mapping relationship between an EID of the host and a RLOC of an immigration
make a determination as to whether the RLOC of the immigration TR is same as an RLOC of the emigration TR;
search for an RLOC of a remote TR if the RLOC of the immigration TR is different from the RLOC of the emigration TR;
send an SMR message to the remote TR using the RLOC of the remote TR to notify the remote TR of requesting for the RLOC of the immigration TR.

In an example of the present disclosure, the machine readable instructions on the non-transitory storage 902 may include instructions executable by the CPU 901, to receive the map notify message carrying the mapping relationship from an MS.

In an example of the present disclosure, when the emigration TR and the immigration TR are located at a same extended Local Area Network (LAN), the machine readable instructions on the non-transitory storage 902 may include instructions executable by the CPU 901 to receive the map notify message carrying the mapping relationship from the immigration TR or the MS.

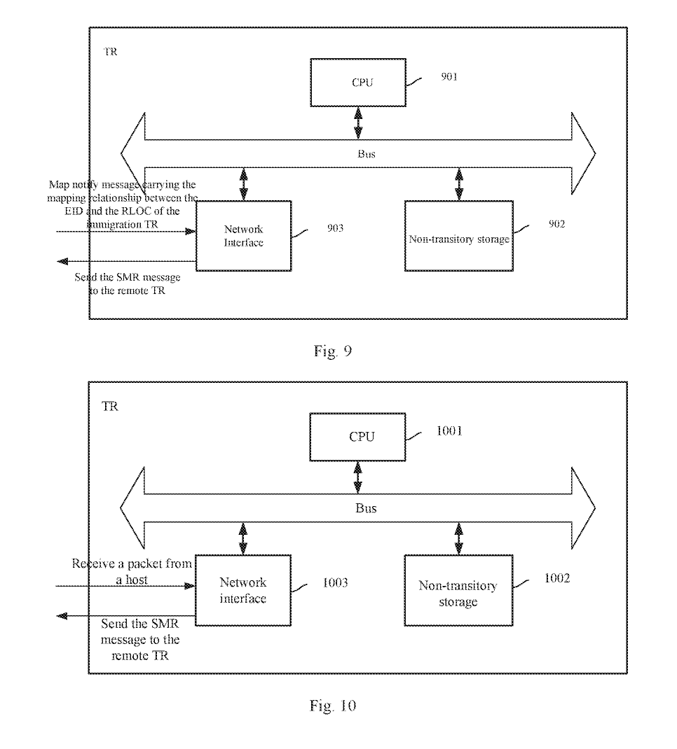

FIG. 10 is a schematic diagram illustrating structure of another TR in accordance with various examples of the present disclosure. The TR may be an immigration TR.

The immigration TR may include: a CPU 1001, a non-transitory storage 1002 and a network interface 1003.

The non-transitory storage 1002 may be configured to store machine readable instructions.

The CPU 1001 may communicate with the non-transitory storage 1002 to read and execute the machine readable instructions on the non-transitory storage 1002, to
receive a packet from the host;
if a destination address of the packet is an RLOC of a remote TR and the packet is a first packet sent to the remote TR after the host migrates to the immigration TR send an SMR message to the remote TR to notify the remote TR of requesting for an RLOC of the immigration TR.

In an example of the present disclosure, the machine readable instructions on the non-transitory storage 1002 may include instructions executable by the CPU1001, to
receive a map request message carrying the RLOC of the remote TR and an EID of the host from the remote TR; and
send a map response message carrying the EID of the host and the RLOC of the immigration TR to the remote TR.

In an example of the present disclosure, the machine readable instructions on the non-transitory storage 1002 may include instructions executable by the CPU 1001, to receive a packet, which is sent from the remote TR to the host using the RLOC of the immigration TR.

In an example of the present disclosure, the machine readable instructions on the non-transitory storage 1002 may include instructions executable by the CPU 1001, to P1 make a determination as to whether the immigration TR records a mapping relationship between an EID of the host and the RLOC of the immigration TR;
if the immigration TR records the mapping relationship between the EID of the host and the RLOC of the immigration TR, search for an RLOC corresponding to a destination EID of the packet from the host;
if the RLOC corresponding to the destination EID of the packet from the host is the BLOC of the remote TR and the packet from the host is a first packet sent from the host to the remote TR after the host migrates to the immigration TR, send the SMR message to the remote TR;
if the immigration TR does not record the mapping relationship between the EID of the host and the RLOC of the immigration TR, search for the RI:0C of the remote TR corresponding to the destination EID of the packet from the host and send the SMR message to the remote TR using the RLOC of the remote TR.

The above device for implementing host migration may be a logical device and may be implemented by reading by the CPU the machine readable instructions in the non-transitory storage to the memory and executing the machine readable instructions. The machine readable instructions may be executed to by the device for implementing host migration to perform corresponding operations in the above LISP host migration methods in examples of the present disclosure.

What is claimed is:

1. A migration method, comprising:
receiving, by an emigration Tunnel Router (TR), a map notify message carrying a mapping relationship between an Endpoint Identity (EID) of the host and a Routing Locator (RLOC) of an immigration TR;
making, by the emigration TR, a determination as to whether the RLOC of the immigration TR is same as an RLOC of the emigration TR;
searching for, by the emigration TR, an RLOC of a remote TR if the RLOC of the immigration TR is different from the RLOC of the emigration TR;
sending, by the emigration TR, a Solicit Map Request (SMR) message to the remote TR using the RLOC of the remote TR to notify the remote TR of requesting for the RLOC of the immigration TR.

2. The method according to claim 1, wherein receiving, by the emigration TR, the map notify message carrying the mapping relationship comprises:
receiving, by the emigration TR, the map notify message carrying the mapping relationship from a Map Server (MS).

3. The method according to claim 1, wherein when the emigration TR and the immigration TR are located at a same extended Local Area Network (LAN), receiving, by the emigration TR, the map notify message carrying the mapping relationship comprises:
receiving, by the emigration TR, the map notify message carrying the mapping relationship from the immigration TR or the MS.

4. A migration method, comprising:
receiving, by an immigration Tunnel Router (TR), a packet from the host;
if a destination address of the packet is a Routing Locator (RLOC) of a remote TR and the packet is a first packet sent to the remote TR after the host migrates to the immigration TR, sending, by the immigration TR, a Solicit Map Request (SMR) message to the remote TR to notify the remote TR of requesting for an RLOC of the immigration TR.

5. The method according to claim 4, further comprising:
receiving, by the immigration TR, a map request message carrying the RLOC of the remote TR and an Endpoint Identity (EID) of the host from the remote TR; and
sending, by the immigration TR, a map response message carrying the EID of the host and the RLOC of the immigration TR to the remote TR.

6. The method according to claim 5, further comprising:
receiving, by the immigration TR, a packet, which is sent from the remote TR to the host using the RLOC of the immigration TR:

7. The method according to claim 4, wherein sending, by the immigration TR, the SMR message to the remote TR comprises:
making, by the immigration TR, a determination as to whether the immigration TR records a mapping relationship between an EID of the host and the RLOC of the immigration TR;
if the immigration TR records the mapping relationship between the EID of the host and the RLOC of the immigration TR, searching for an RLOC corresponding to a destination EID of the packet from the host;
if the RLOC corresponding to the destination EID of the packet from the host is the RLOC of the remote TR and the packet from the host is a first packet sent from the host to the remote TR after the host migrates to the immigration TR, sending the SMR message to the remote TR;
if the immigration TR does not record the mapping relationship between the EID of the host and the RLOC of the immigration TR, searching for the RLOC of the remote TR corresponding to the destination EID of the packet from the host and sending the SMR message to the remote TR using the RLOC of the remote TR.

8. A Tunnel Router (TR), wherein the TR is an emigration TR and the emigration TR comprises: a processor and
a non-transitory storage medium storing machine readable instructions that are executable by the processor to:
receive a map notify message carrying a mapping relationship between an Endpoint Identity (EID) of the host and a Routing Locator (RLOC) of an immigration TR;
make a determination as to whether the RLOC of the immigration TR is same as an RLOC of the emigration TR;
search for an RLOC of a remote TR if the RLOC of the immigration TR is different from the RLOC of the emigration TR;
send a Solicit Map Request (SMR) message to the remote TR using the RLOC of the remote TR to notify the remote TR of requesting for the RLOC of the immigration TR.

9. The TR according to claim 8, wherein the machine readable instructions comprise instructions to:
receive the map notify message carrying the mapping relationship from a Map Server (MS).

10. The TR according to claim 8, wherein when the emigration TR and the immigration TR are located at a same extended Local Area Network (LAN), and the machine readable instructions comprise instructions executable by the processor to,
receive the map notify message carrying the mapping relationship from the immigration TR or the MS.

11. A Tunnel Router (TR), wherein the TR is an immigration TR and the immigration TR comprises: a processor and a non-transitory⁻ storage medium storing machine readable instructions executable by the processor to:
receive a packet from the host;
if a destination address of the packet is a Routing Locator (RLOC) of a remote TR and the packet is a first packet sent to the remote TR after the host migrates to the immigration TR, send a Solicit Map Request (SMR) message to the remote TR to notify the remote TR of requesting for an RLOC of the immigration TR.

12. The TR according to claim II, wherein the machine readable instructions further comprise instructions executable by the processor to:
receive a map request message carrying the RLOC of the remote TR and an Endpoint Identity (EID) of the host from the remote TR; and)
send a map response message carrying the EID of the host and the RLOC of the immigration TR to the remote TR.

13. The TR according to claim 12, wherein the machine readable instructions comprise instructions executable by the processor to:
receive a packet, which is sent from the remote TR to the host using the RLOC of the immigration TR.

14. The TR according to claim 11, wherein the machine readable instructions comprise instructions executable by the processor to:
make a determination as to whether the immigration TR records a mapping relationship between an EID of the host and the RLOC of the immigration TR;
if the immigration TR records the mapping relationship between the EID of the host and the RLOC of the immigration TR, search for an RLOC corresponding to a destination EID of the packet from the host;
if the RLOC corresponding to the destination EID of the packet from the host is the RLOC of the remote TR and the packet from the host is a first packet sent from the host to the remote TR after the host migrates to the immigration TR, send the SMR message to the remote TR;
if the immigration TR does not record the mapping relationship between the EID of the host and the RLOC of the immigration TR, search for the RLOC of the remote TR corresponding to the destination EID of the packet from the host and send the SMR message to the remote TR using the RLOC of the remote TR.
